(19) United States
(12) Patent Application Publication
(10) Pub. No.: US 2004/0036953 A1
(43) Pub. Date: Feb. 26, 2004

(54) Driving methods for an electronic display

(76) Inventors: Helen M. Davis, Cupertino, CA (US); George Lee Ackerson, Ben Lomond, CA (US); Bryan Thomas Preas, Palo Alto, CA (US)

Correspondence Address: Pepper Hamilton LLP, One Mellon Center, 50th Floor, 500 Grant Street, Pittsburgh, PA, 15219, US

(21) Appl. No.: 10/396,642

(22) Filed: Mar. 25, 2003

Related U.S. Application Data
(60) Provisional application No. 60/367,240, filed on Mar. 25, 2002.

(51) Int. Cl. G02B 26/00

(52) U.S. Cl. 359/296

(57) ABSTRACT

A method of creating or changing an image on an electric paper display includes selectively applying electric fields to various regions of bichromal media. The methods may apply the fields in a manner such that the vector sum of all fields applied equals zero, and/or the methods may wipe clean the bichromal media so that a single-color screen is displayed before a new image is applied.

### RELATED APPLICATIONS AND CLAIM OF PRIORITY

This application claims priority to, and incorporates by reference, the co-pending U.S. provisional patent application No. 60/367,240, filed Mar. 25, 2002, titled “Driving Methods for Gyricon Display.”

### FIELD OF THE INVENTION

This invention relates to electronically programmable and/or controllable signs. More specifically, this invention relates to methods of creating and/or changing images on rotating ball displays, twisting cylinder displays and the like.

### BACKGROUND OF THE INVENTION

Traditional signs have based upon printed materials, paper, plastic, metal, etc., and are therefore not programmable. Accordingly, they are not easily changed. In an attempt to overcome this problem, electronically programmable and/or controllable signs have been in existence for many years. For example, liquid crystal diode (LCD) displays, cathode ray tube (CRT) displays, and other electrically-addressable displays will display an image in response to applied electric signals or fields. However, such signs typically require a large amount of electricity, since they must provide illumination in order to be visible to a viewer.

Electrical twisting-cylinder and rotary ball displays, such as those described in U.S. Pat. Nos. 4,126,854 and 4,143,103, incorporated herein by reference in their entirety, have been developed to overcome the problems with previous programmable signs. Twisting-cylinder displays, rotary-ball displays and related displays have numerous advantages over conventional displays, such as LCD and CRT, since they are suitable for viewing in ambient light, they retain an image indefinitely in the absence of an applied electric field, and they can be made to be very lightweight and/or flexible. For further advantages of such displays, see U.S. Pat. No. 5,389,945, incorporated herein by reference in its entirety. Such displays are referred to herein as “electric paper” displays. An example of such a display is a SmartPaper™ display, from Gyricon Media, Inc.

An image can be created or changed on an electric paper display by applying an electric field to the twisting cylinders or rotating balls. Prior methods of creating image on electric paper displays have resulted in images that may not be “sharp,” and which may have blurred edges or which may degrade over time. In addition, some prior methods of changing an image on an electric paper display show a portion of the old image while a new image is being loaded.

Accordingly, we have found it desirable to provide an improved method of forming an image on an electric paper display as described herein.

### SUMMARY OF THE INVENTION

In accordance with a preferred embodiment of the invention, a method of displaying an image on a display device is provided. The display device includes a conductive substrate, a layer of bichromal media having a plurality of regions, and a transparent conductive layer. The bichromal media is positioned between the substrate and the conductive layer. The method includes the following steps, in sequence: (1) applying an electric field having a first polarity to a first region; (2) applying an electric field having a second polarity to a second region, wherein the second polarity is opposite the first polarity; and (3) and reversing the polarities of each of the electric fields, wherein the bichromal media associated with the first region displays a first color and the bichromal media associated with the second region displays a second color after the polarities are reversed.

In accordance with an alternate embodiment of the invention, a method of displaying an image on a display device is also provided. The display device includes a conductive substrate, a layer of bichromal media having a plurality of regions, and a transparent conductive layer. The bichromal media is positioned between the substrate and the conductive layer. The method includes the following steps in sequence: (1) applying an electric field having a first polarity to two or more of the regions; (2) applying an electric field having a second polarity to the two or more regions, wherein the second polarity is opposite the first polarity; (3) re-applying an electric field having the first polarity to the two or more regions; and (4) applying an electric field having the second polarity to one of the two regions while maintaining the electric field having the first polarity on the other of the two regions.

In accordance with an alternate embodiment of the invention, a method of displaying an image on a display device is again provided. The display device includes a substrate including conductive pixels, a layer of bichromal media having a plurality of regions, wherein each region is associated with at least one pixel, and a transparent conductive layer.

The bichromal media is positioned between the substrate and the conductive layer. The method includes the steps of: (1) applying an electric field having a polarity to all of the pixels; (2) reversing the polarity of the electric field and applying the reversed polarity electric field to all of the pixels; (3) applying an electric field to a first group of pixels so that all electric field regions of bichromal media associated with the first group are caused to display a first color; and (4) applying an electric field to a second group of pixels so that all regions of bichromal media associated with the second group are caused to display a second color.

### BRIEF DESCRIPTION OF THE DRAWINGS

FIG. 1 is a cross-sectional view of an exemplary electric paper display device with plate and pixel drivers;

FIGS. 2A through 2D are diagrammatic representations of the basic driving operations on electric paper displays;

FIG. 3 illustrates waveforms that are representative of an embodiment of the four-phase driving method of the invention;

FIGS. 4A through 4D are diagrammatic representations of the driving operations of the four-phase driving method described in FIG. 3;

FIG. 5 illustrates waveforms that are representative of an alternate embodiment of the driving method of the invention;

FIGS. 6A through 6H are diagrammatic representations of an alternate symmetric image change embodiment; and

FIG. 7 illustrates waveforms for the symmetric image change driving method illustrated in FIGS. 6A through 6H.

### DETAILED DESCRIPTION OF THE PREFERRED EMBODIMENTS

A basic structure of an electric paper display is shown in U.S. Pat. No. 4,126,854, incorporated herein by reference. This invention relates to the electrical interface and methods of applying voltage waveforms to create and change images on (i.e., to “drive”) electric paper.

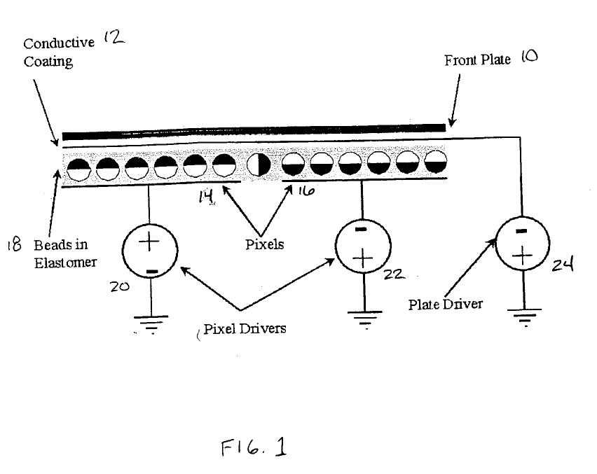

An example of the basic elements of an exemplary electric paper display structure is illustrated in FIG. 1. In this illustration, the electric paper display includes a layer of beads or balls 18. Each of the balls has two distinct hemispheres, one having a first color (such as black) and the other having a second color (such as white). Each hemisphere of each ball has a distinct electrical characteristic so that the balls are electrically anisotropic. Instead of balls, cylinders and other shapes may be used, so long as each item is rotatable and has distinct half-areas with distinct colors.

The balls are embedded in an optically transparent material, such as an elastomer layer. Preferably, the elastomer layer contains a multiplicity of spheroidal cavities (or cavities of other shapes if cylinders or other items are used in the layer) and is permeated by a transparent dielectric fluid, such as a plasticizer. The fluid-filled cavities accommodate the balls, one ball per cavity, so as to prevent the balls from migrating within the sheet. FIG. 1 illustrates the layer of balls 18 being formed such that the balls are in a straight line. However, the illustrated example is not meant to be limiting, and this invention may be used with any three-dimensional grouping of the balls.

The ball layer 18 is sandwiched between a transparent conductive coating, which is covered by or integral with front plate 10, and a plurality of conductive pixels such as 14 and 16 formed on a substrate as shown in FIG. 1. The front plate 10 is typically plastic (such as Mylar®) or glass. The conductive layer 12 may be made, for example, of indium tin oxide (ITO) to provide both transparency and the ability to apply a uniform electric field. As used herein, the term “transparent” is intended to include substantially transparent.

A ball can be selectively rotated within its fluid-filled cavity by the application of an electric field to the pixel located under the cavity. Thus, the application of a field to a pixel will present either the black or the white hemisphere of the balls located over the pixel to an observer viewing the surface of the sheet (i.e., the front plate). Thus, by application of an electric field addressable in two dimensions (as by a matrix addressing scheme), the black and white sides of the balls can be caused to appear as the image elements (e.g., pixels or subpixels) of a displayed image. Note that the use of black and white hemispheres is only illustrative, and that other colors may be used.

The electric field is generated by the voltage sources, specifically, by pixel drivers 20 and 22 and the plate driver 24. The number of pixels and pixel drivers illustrated in FIG. 1 is only intended to serve as an example, and any number of pixels and pixel drivers may be used.

Electrical fields impressed across the electric paper can set the optical state, or color, of an electric paper supply. These electric fields are generated by voltage waveforms. This invention applies to all forms of electric paper that form stable, static images. When this is the case, the image remains static when external voltages are removed. In other words, the application of an electric field may cause a ball to rotate, but the removal of the field will not change the position or orientation of the ball.

Surprisingly and advantageously, we have discovered that there are forms of electric paper that benefit from symmetric driving fields. For example, the electric paper display structure illustrated in FIG. 1 produces a higher contrast and a more uniform appearance when the driving waveforms are symmetric. Here, symmetric driving fields mean that sum over time of the applied electrical field is zero: Σ₁ e=0 where e is the electric field seen by the electric paper and t is time.

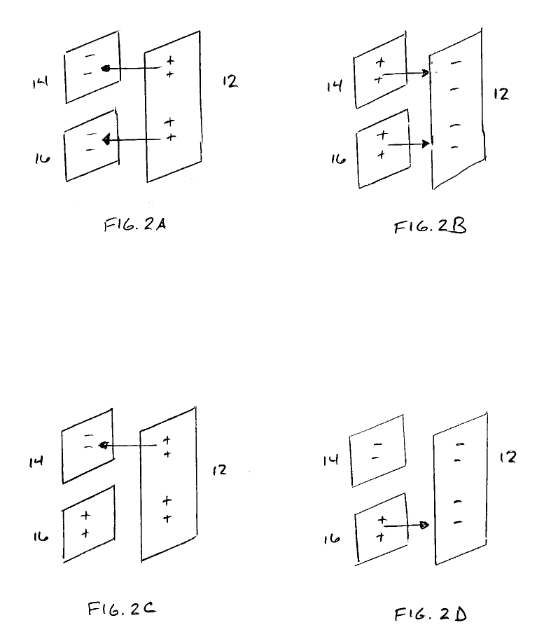

The beads each have an intrinsic electric dipole so that the orientation of the bead will conform to an applied electric field. This is illustrated in FIGS. 2A through 2D. As shown in FIG. 2A, when the field of the conductive layer 12 of the front plate is positive while pixels 14 and 16 are negative, a field (represented by the arrows) is generated so that the white side of the balls associated with each of pixels 14 and 16 may be seen through the front plate. Conversely, as shown in FIG. 2B, a negative conductive layer 12 and positive pixels 14 and 16 may cause the black side of the beads to be seen through the front plate. Throughout this document, the colors black and white are used only to illustrate contrasting examples; in fact any two colors, which may include two shades of a single color, may be used within the scope of the invention.

When the pixel voltage is the same as the plate voltage, the beads controlled by that pixel will not change. Examples of such a condition are shown in FIGS. 2C and 2D. Thus, as illustrated in FIG. 2C, if we start with an image where the black sides of all the balls are facing the viewer, we can drive the pixels associated with pixel 14 white by making pixel 14 negative with respect to conductive layer 12. Since both pixel 16 and conductive layer 12 are positive, no field is generated between the conductive layer 12 and pixel 16, and the balls associated with pixel 16 remain black to the viewer. Conversely, if all balls begin in the black position, we can drive some of them white by making certain pixels positive with respect to a negative conductive layer. In FIG. 2D, pixel 16 is positive and pixel 14 and conductive layer 12 are negative, so the balls associated with pixel 14 will rotate to the white position.

In FIG. 2, standard directions are used to illustrate the electric field lines. As shown, electric field lines originate on positive charges and terminate on negative charges. No electric field is present between charges at the same voltage.

Surprisingly and advantageously, we have discovered new methods of changing the image displayed on the electric paper while maintaining the symmetry of the applied field. The methods are referred to herein as four phase, black/white, and symmetric.

Four Phase Image Change

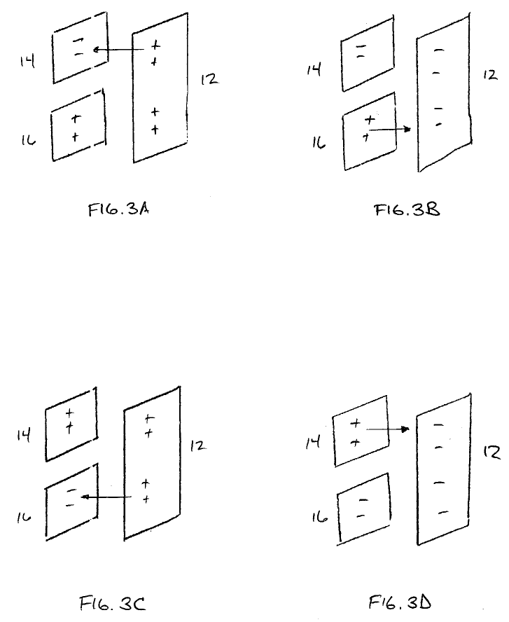

The four-phase image change method applies a symmetric field to the electric paper. Referring to FIGS. 3A through 3D, we again illustrate in each Figure two pixels 14 and 16 and the conductive layer 12 of a front plate, In practice, the electric paper will likely include many more than two pixels, and in general, the images may be very complex. For purposes of this illustration, pixel 14 represents all of the pixels that will end up as a first color (in this example, black) in the final image, while pixel 16 represents all of the pixels that will end up as a second color (in this example, white) in the final image. Thus, in the final image, pixel 16 will be white and pixel 14 will be black. It does not matter which position the pixels are in at the beginning of the method.

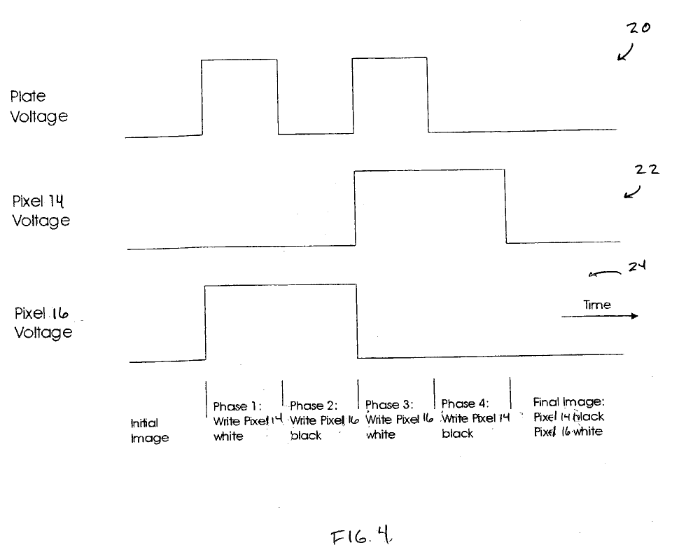

Referring to FIG. 4, electric fields are applied to the pixel drivers and plate drivers so that a plate voltage 20 is applied to the conductive layer of the front plate. One voltage 22 is applied to pixel 14, while another voltage 24 is applied to pixel 16.

The application of the electric fields illustrated in FIG. 4 changes the pixels as follows. Referring to FIG. 3A, plate voltage 20 is positive, pixel 14 voltage is negative, and pixel 16 voltage is positive. In this example, the electrical characteristics of the balls (or other bichromal objects) located between the pixels and the plate are such that the combination of a positive charge on the plate and a negative charge on a pixel will cause the white side of the balls to face the plate. Thus, all of the balls associated with pixel 14 will position themselves so that the white hemisphere of each ball faces the front plate. Of course, other colors may be used, and the color white is only discussed here for illustration. Note that the balls associated with pixel 16 are not changed by this phase, since a positive charge is applied to both pixel 16 and the conductive layer 12.

Referring to FIG. 3B, in the next phase pixel 16 is written black (i.e., the balls associated with pixel 16 are positioned so that the black hemispheres face the front plate) when the conductive layer 12 of the plate is negative, pixel 14 is negative and pixel 16 is positive. Note that the pixel 14 is not changed by this operation. In this example, the electrical characteristics of the balls (or other bichromal objects) located between the pixels and the plate are such that the combination of a negative charge on the plate and a positive charge on a pixel will cause the black side of the balls to face the plate. Thus, all of the balls associated with pixel 16 will position themselves so that the black hemisphere of each ball faces the front plate. Of course, other colors may be used, and the color black is only discussed here for illustration.

At this point, after the first and second phases, all of the balls associated with pixel 14 are in a first color position (i.e., white), while all of the balls associated with pixel 16 are in a second color position (i.e., black). Thus, the first and second steps write all pixels to the first, and then the second, color position. The next phases allow the colors of pixels 14 and 16 to be swapped.

Referring to FIG. 3C, in the third phase of the method the conductive layer 12 of the plate is positive, pixel 14 is positive, and pixel 16 is negative. Thus, all of the pixels associated with pixel 16 will be written white. Here, pixel 16 represents all pixels that are desired to be written white in the final image. Note that pixel 14 is not changed by this operation.

Referring to FIG. 3D, in the final phase of the method the conductive layer 12 of the plate negative, pixel 14 is positive, and pixel 16 is negative. Thus, all of the pixels associated with pixel 14 will be written black. Note that pixel 16 is not changed by this operation. Here, pixel 14 represents all pixels that are desired to be written black in the final image.

As can be seen from the field lines in FIGS. 3A-3D, the fields are symmetric because the vector sum of the electrical fields equals zero. Accordingly, each ball sees the same electrical field amount, and a crisper image is created. In addition, we have found that the application of an evenly distributed field extends the life of the image layer, as the beads turn better if they are turned more frequently. However, this embodiment has the property that part of the previous image and part of the new image can be seen during the first phase. This can be seen in FIG. 3A, where pixel 16 retains its state from the initial image.

Black/White Image Change

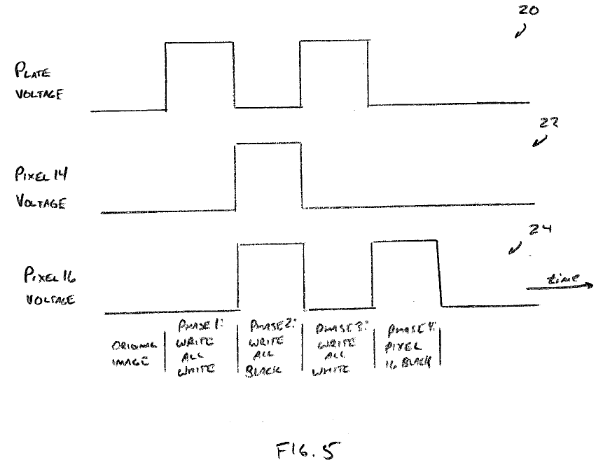

In accordance with an alternate embodiment, a black/white image change method applies a slightly asymmetric field to the electric paper. Again, the colors black and white are merely used as an example, and any two colors, or two shades of a single color, may be used. As illustrated in FIG. 5, the pixels that will end in a white position (represented by pixel 14) experience less total field than the black pixels represented by pixel 16). However, it has the desirable property that only complete, whole images are displayed. Referring to FIG. 5, the waveform sequence is:

Phase 1: plate voltage 20 positive, pixel 14 voltage (22) and pixel 16 voltage (24) both negative, causing all pixels to move to a first color position, in this example white;

Phase 2: plate voltage 20 negative, pixel 14 voltage (22) and pixel 16 voltage (24) both positive, causing all pixels to move to a second color position, in this example black;

Phase 3: plate voltage 20 positive, pixel 14 voltage (22) and pixel 16 voltage (24) both negative, causing all pixels to return to the first color position, in this example white; and

Phase 4: plate voltage 20 and pixel 14 voltage (22) negative, pixel 16 voltage (24) positive, causing only the pixels associated with pixel 16 to move to the second color position, in this example black.

Thus, in this embodiment, all balls are turned at least twice before the balls representing the final image is turned. Some balls are turned three times. This provides a “clean slate” on which to display the final image.

Symmetric Image Change

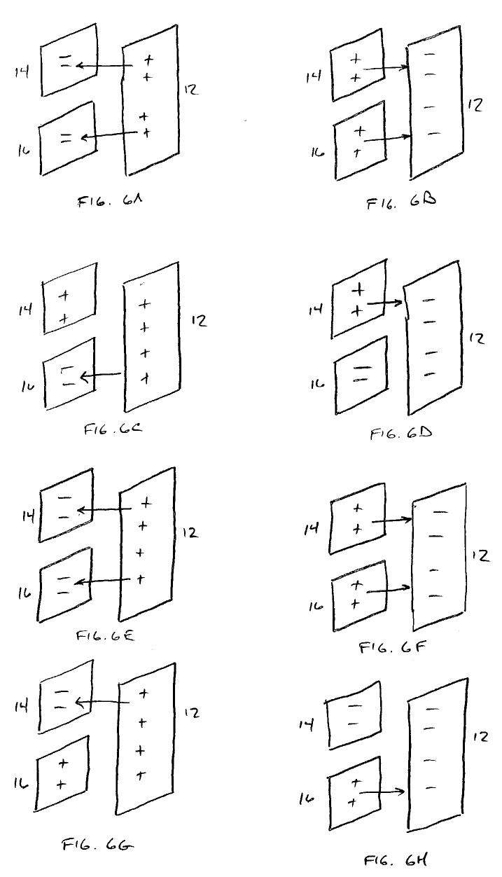

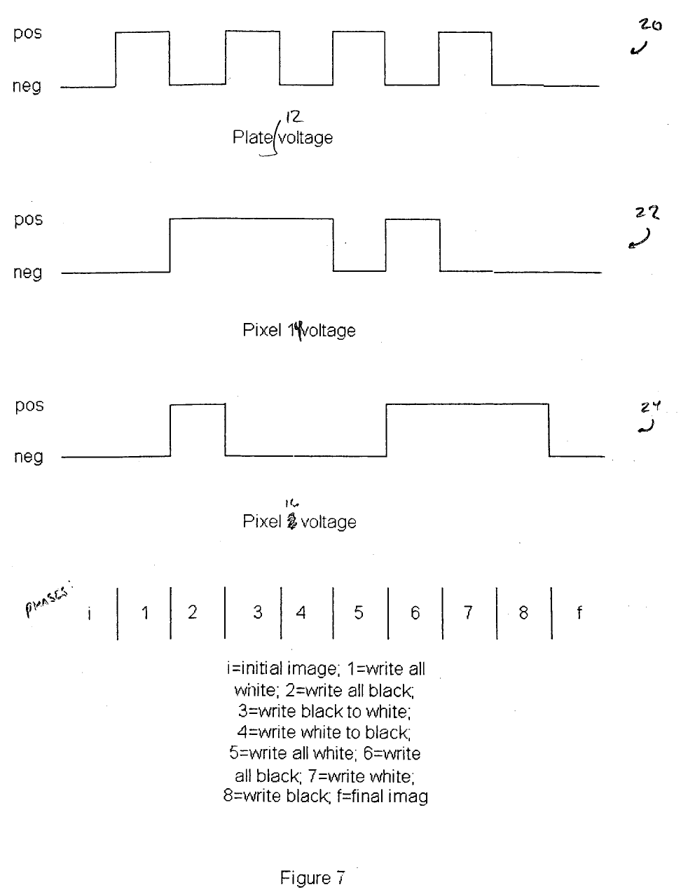

In accordance with an alternate embodiment, a symmetric image change method applies a symmetric field to the electric paper. It also has the desirable property that only complete, whole images are displayed. Referring to FIGS. 6 and 7, the waveform sequence is:

Phase 1 (FIG. 6A): plate 12 voltage (20) positive, pixel 14 voltage (22) and pixel 16 voltage (24) both negative, causing all pixels to move to a first color position, in this example white;

Phase 2 (FIG. 6B): plate 12 voltage (20) negative, pixel 14 voltage (22) and pixel 16 voltage (24) both positive, causing all pixels to move to a second color position, in this example black;

Phase 3 (FIG. 6C): plate 12 voltage (20) and pixel 14 voltage (22) positive, pixel 16 voltage (24) negative, causing only the pixels associated with pixel 16 to move to the first color position (white);

Phase 4 (FIG. 6D): plate 12 voltage (20) and pixel 16 voltage (24) negative, pixel 14 voltage (22) positive, causing only the pixels associated with pixel 14 to move to the second color position (black). Note that prior to this step, pixel 14 was already black because of Phase 2. However, this step helps to keep the symmetry of the vector sum of the applied electric fields. In addition, it helps to erase the old image before the new image is written.

Phase 5 (FIG. 6E): plate 12 voltage (20) positive, pixel 14 voltage (22) and pixel 16 voltage (24) both negative, causing all pixels to return to the first color position (white);

Phase 6 (FIG. 6F): plate 12 voltage (20) negative, pixel 14 voltage (22) and pixel 16 voltage (24) both positive, causing all pixels to return to the second color position (black);

Phase 7 (FIG. 6G): plate 12 voltage (20) and pixel 16 voltage (24) positive, pixel 14 voltage (22) negative, causing only the pixels associated with pixel 14 to move to the first color position (white); and

Phase 8 (FIG. 6H): plate 12 voltage (20) and pixel 14 voltage (22) negative, pixel 16 voltage (24) positive, causing only the pixels associated with pixel 16 to move to the second color position (black).

Thus, in the final two phases, pixel 14 represents all pixels that are to appear as a first color (e.g., white) in the final image, while pixel 16 represents all pixels that are to appear as a second color (e.g., black) in the final image. Phases 1-6 provide symmetry and a “clean slate” to provide a sharper picture, improved media life, and no overlapping of image.

The invention is not limited in its application to the details of construction and to the arrangements of the components disclosed herein or illustrated in the drawings. The invention is capable of other embodiments and of being practiced and carried out in various ways. Also, it is to be understood that the phraseology and terminology employed herein is used for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of displaying an image on a display device, wherein the display device includes a substrate including conductive sections, a layer of bichromal media having a plurality of regions, and a transparent conductive layer, wherein the bichromal media is positioned between the substrate and the conductive layer, the method comprising the following steps, in sequence:
applying an electric field having a first polarity to a first region;
applying an electric field having a second polarity to a second region, wherein the second polarity is opposite the first polarity; and
reversing the polarities of each of the electric fields, wherein the bichromal media associated with the first region displays a first color and the bichromal media associated with the second region displays a second color after the polarities are reversed.

2. The method of claim 1 wherein the vector sum of the electric fields applied equals zero.

3. A method of displaying an image on a display device, wherein the display device includes a conductive substrate, a layer of bichromal media having a plurality of regions, and a transparent conductive layer, wherein the bichromal media is positioned between the substrate and the conductive layer, the method comprising the following steps in sequence:
applying an electric field having a first polarity to two or more of the regions;
applying an electric field having a second polarity to the two or more regions, wherein the second polarity is opposite the first polarity;
re-applying an electric field having the first polarity to the two or more regions; and
applying an electric field having the second polarity to one of the two regions while maintaining the electric field having the first polarity on the other of the two regions.

4. The method of claim 4 wherein, after the final step, one of the two regions displays a first color or shade while the other region displays a second color or shade.

5. The method of claim 4 wherein the vector sum of the applied electric fields does not equal zero.

6. A method of displaying an image on a display device, wherein the display device includes a substrate including conductive pixels, a layer of bichromal media having a plurality of regions, each region associated with at least one pixel, and a transparent conductive layer wherein the bichromal media is positioned between the substrate and the conductive layer, the method comprising:
applying an electric field having a polarity to all of the pixels;
reversing the polarity of the electric field and applying the reversed polarity electric field to all of the pixels;
applying an electric field to a first group of pixels so that all regions of bichromal media associated with the first group are caused to display a first color; and
applying an electric field to a second group of pixels so that all regions of bichromal media associated with the second group are caused to display a second color.

7. The method of claim 6 wherein the vector sum of the electric fields applied equals zero.
